(19) United States
(12) Patent Application Publication
(10) Pub. No.: US 2003/0023737 A1
(43) Pub. Date: Jan. 30, 2003

(54) Message accumulation for communication processes using a common protocol

(76) Inventors: Peter E. Johnson, Lehi, UT (US); Ryan B. Erickson, Lehi, UT (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/883,615

(22) Filed: Jun. 18, 2001

(51) Int. Cl. G06F 15/16

(52) U.S. Cl. 709/230; 709/203

(57) ABSTRACT

In one embodiment, a method comprises receiving a number of messages from at least two different system elements that are located in two different devices. The system elements are associated with a same process, and the number of messages have a common protocol. The method also includes storing the number of messages from the at least two different system elements. Additionally, the method comprises retrieving the number of messages associated with the same process upon request for a status inquiry of the same process.

### FIELD

The invention relates to communications among processes executing across different devices. More specifically, the invention relates to message accumulation for communications among processes executing across different devices using a common protocol.

### BACKGROUND

With the increase in network communications, the amount of remote maintenance and installation of different components, such as an operating system, onto electronic devices continues to increase. Typically, a communication process is employed to allow for these different types of remote maintenance of and/or installation into electronic devices. Additionally, a given communication process can require action by different software processes executing across the different devices (hereinafter, such processes are termed system elements). Each of the different system elements produces a number of different status and/or error messages to allow for the monitoring of the communication process. Accordingly, a system administrator performing maintenance or installations must track and monitor these different status and error messages from the different system elements across the different devices.

Moreover, each of these system elements typically provides their own mechanism for outputting the status and/or error messages involved during the communication process. Some system elements can output their status and error messages to a display monitor. Other system elements can output their status and error messages to a log file written to disk. Further complicating the tracking and monitoring of the different system elements is that some devices on which the system elements are executing are headless. In other words, such devices do not include a monitor for interactive viewing, thereby making the monitoring of these system elements more difficult. Further, the Internet Protocol (IP) address for a given device can change during the course of certain installations and during configuration of the device, thereby making the process of tracking the status and error messages for a given communication process more difficult. For example, when an electronic device is initially booted without an operating system, the server, which downloads the operating system to the electronic device, dynamically assigns an IP address to this electronic device. However, subsequent to the operating system installation, the electronic device may be given a static IP address provided by the files downloaded for the operating system installation. Accordingly, the tracking of the status and/or error messages by a system administrator becomes increasingly difficult as a given communication process can be distributed across a number of system elements on a number of different devices.

### BRIEF DESCRIPTION OF THE DRAWINGS

Embodiments of the invention may be best understood by referring to the following description and accompanying drawings which illustrate such embodiments. The numbering scheme for the Figures included herein are such that the leading number for a given element in a Figure is associated with the number of the Figure. For example, system 100 can be located in FIG. 1. However, element numbers are the same for those elements that are the same across different Figures.

FIG. 1 illustrates a system for aggregating information messages for the installation of an operating system, according to embodiments of the present invention.

FIG. 2 illustrates a flow diagram of providing message accumulation for a communication process distributed across a number of devices, according to embodiments of the present invention.

FIG. 3 illustrates a message format for messages transmitted to message accumulator unit 108, according to embodiments of the present invention.

FIG. 4 illustrates a flow diagram of retrieving messages for a given communication process from message accumulator unit 108, according to embodiments of the present invention.

FIG. 5 illustrates a system application for accumulating and retrieving of messages for communication processes, according to embodiments of the present invention.

FIG. 6 illustrates a more detailed diagram of a system application for accumulating and retrieving of messages for communication processes, according to embodiments of the present invention.

FIG. 7 illustrates a computer system that includes a machine-readable medium on which is stored a set of instructions according to embodiments of the present invention.

### DETAILED DESCRIPTION

In the following description, numerous specific details are set forth to provide a thorough understanding of the invention. However, it is understood that the invention may be practiced without these specific details. In other instances, well-known structures and techniques have not been shown in detail in order not to obscure embodiments of the present invention.

### System Embodiment

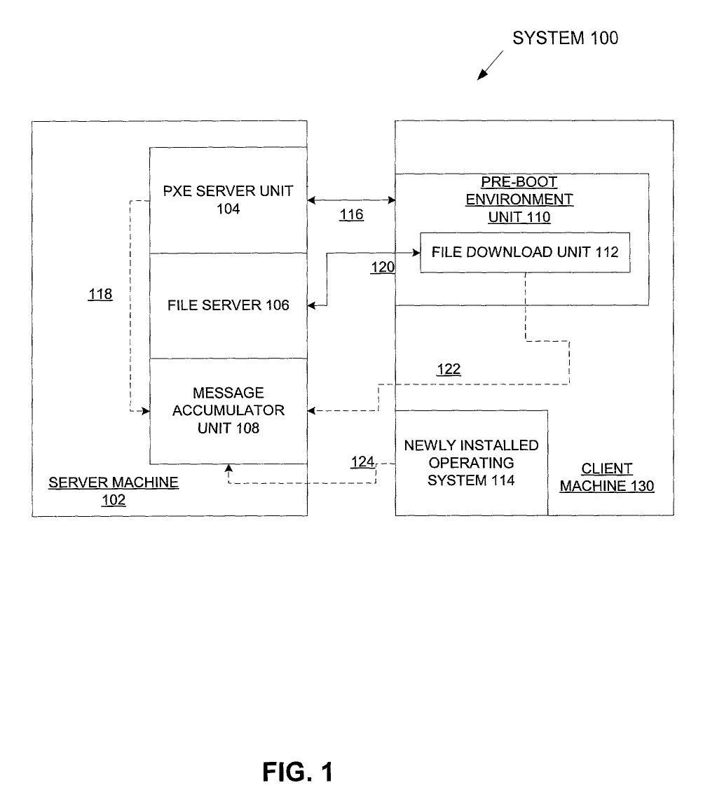

FIG. 1 illustrates a system for accumulating messages for the installation of an operating system, according to embodiments of the present invention. Although described in the context of an operating system installation within system 100 of FIG. 1, embodiments of the present invention may be implemented in other suitable systems for performing message aggregation. For example, in another embodiment, the system could be installing different types of software applications or performing a maintenance update.

As illustrated in FIG. 1, system 100 comprises server machine 102 and client machine 130 that are communicatively coupled together. In one embodiment, server machine 102 is coupled to client machine 130 through a wired communication link. In another embodiment, server machine 102 is coupled to client machine 130 through a wireless communication link. Additionally, system 100 illustrates a number of communications, which include communications 116, 120, 122 and 124, between server machine 102 and client machine 130. Such communications can be transmitted by one or more communications links.

Both server machine 102 and client machine 130 include a number of system elements or execution units. In particular, server machine 102 includes a local execution units—Preboot eXecution Environment (PXE) server unit 104. Server machine 102 also includes file server 106 and message accumulator unit 108. Additionally, client machine 130 includes a number of remote system elements or execution units that include pre-boot environment unit 110 and newly installed operating system 114. Pre-boot environment unit 110 also includes file download unit 112. FIG. 1 also illustrates a number of communications between the different components and units of server machine 102 and client machine 130. In particular, FIG. 1 illustrates communications 116, 118, 120, 122 and 124.

### Message Accumulation

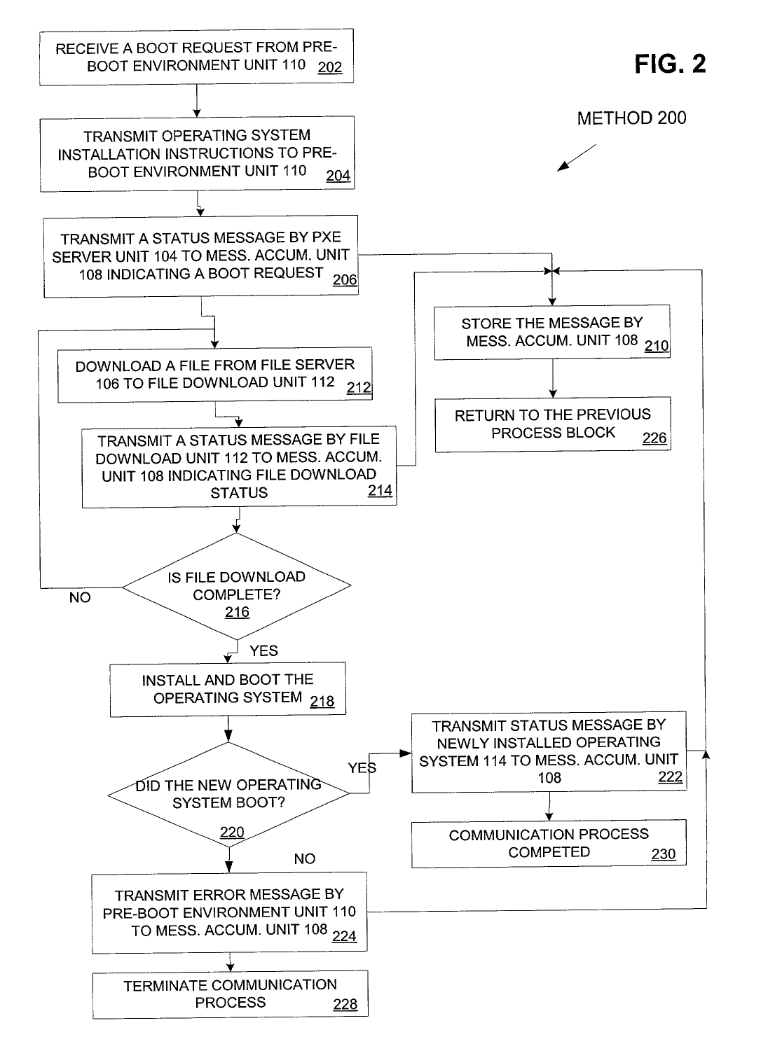

The operation of system 100, according to embodiments of the present invention, will now be described in conjunction with the flow diagram illustrated in FIG. 2. In particular, FIG. 2 illustrates a flow diagram of providing message accumulation for a communication process distributed across a number of devices, according to embodiments of the present invention. The flow diagram of FIG. 2 for message accumulation employs a communication process that allows for the installation of an operating system. However, embodiments of the present invention are not so limited, as embodiments of the present invention can be incorporated into any other type of communication process that generates and accumulates messages, such as status and/or error messages. For example, embodiments of the present invention can be incorporated into other types of software installations and/or maintenance updates of components of different electronic devices.

Method 200 commences with a boot request from pre-boot environment unit 110 that is received by PXE server unit 104 using communication 116, at process block 202. This request can be initiated when client machine 130 is initially powered up and does not include an operating system. In another embodiment, this boot request can be transmitted from a different machine, such as server machine 102, to re-install the operating system on client machine 130. For example, a machine that is communicatively coupled to client machine may be receiving error messages that indicate that the operating system on client machine 130 may be corrupted. Accordingly, this machine can transmit a boot request to client machine 130, which in turn, transmits such a request to server machine 102.

PXE server unit 104 transmits operating system installation instructions to pre-boot environment unit 110 using communication 116, at process block 204. Such instructions can include the number of files to be downloaded, the location of such files within file server 106 and the process to follow to complete the installation of the files subsequent to the download. Additionally, PXE server unit 104 transmits a status message to message accumulator unit 108 to indicate the receipt of a boot request from pre-boot environment unit 110 through communication 118, at process block 206.

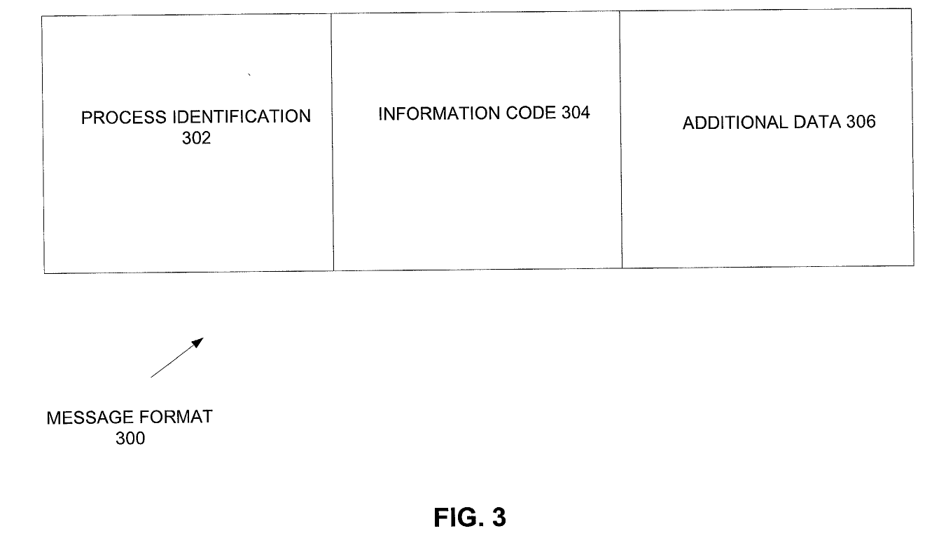

In an embodiment, the different messages received by message accumulator unit 108 have a same common protocol. In one embodiment, this same common protocol is the HyperText Transfer Protocol (HTTP). In an embodiment, the format of the messages received by message accumulator unit 108 is the same. FIG. 3 illustrates a message format for messages transmitted to message accumulator unit 108, according to embodiments of the present invention. FIG. 3 shows message format 300 that includes process identification 302, information code 304 and additional data 306. The message format illustrated within FIG. 3 is by way of example and not by way of limitation, as other types of formats that incorporate other types of data in different combinations can be used by embodiments of the present invention.

Process identification 302 is an identifier for the given communication process, such as the installation of an operating system. In an embodiment, this identifier is the Ethernet hardware address of the client machine. However, embodiments of the present invention are not so limited, as the identifier can be any other type of information that uniquely identifies the communication process. In another embodiment, multiple processes can be occurring for a given client device. Accordingly, in one embodiment, the Ethernet hardware address in conjunction with a unique number for the particular communication process could be the identifier for the process.

Message format 300 also includes information code 304. In an embodiment, information code 304 is a status or error code associated with the communication process identified by process identification 302. These codes can be part of a uniform set of codes for all communication processes that transmit messages to message accumulator 108. For example, one type of error code could identify that corrupted data is being received by client machine 130. Another type of error code could identify the inability to communicate with client machine 130. Examples of status codes include, but are not limited to, receipt of a download request and that a file had been received based on such a download request.

Further, message format 300 includes additional data 306. In an embodiment, additional data 306 is used to provide additional information to the end user, such as the administrator installing the operating system. In one such embodiment, this additional information can include the percentage of files downloaded for a given download request. Other types of additional information can include the names and sizes of the files being downloaded.

Returning to FIG. 2, message accumulator unit 108 stores the message transmitted by PXE server unit 104, at process block 210. In an embodiment, message accumulator unit 108 is able to receive and store messages from multiple communication processes. Accordingly, in one such embodiment, message accumulator unit 108 stores the messages from different communication processes in file(s) such that the messages can be retrieved and viewed from a particular communication process. In an embodiment, message accumulator unit 108 includes an HTTP server with a Common Gateway Interface (CGI) that accepts and stores the messages in file(s). Therefore, as will be described in more detail below, message accumulator unit 108 can filter the contents of the file(s) to retrieve and show all messages for a given communication process. As illustrated by FIG. 2, method 200 returns to the previous process block after storage of the message by message accumulator unit 210, at process block 226.

Accordingly, method 200 commences processing wherein file download unit 112 on client machine 130 begins downloading a file needed for the operating system installation from file server 106, through communication 120 at process block 212. Additionally, file download unit 112 transmits a status message to message accumulator unit 108 indicating the file download status, through communication 122 at process block 214. In one embodiment, this status message is transmitted using the HTTP standard. Moreover, in an embodiment, this status message employs the message format illustrated in FIG. 3, as described above. In one such embodiment, additional data 306 within message format 300 includes a percentage of files that have already been downloaded from file server 106 in reference to the total number needed to be downloaded.

Message accumulator unit 108 stores this status message based on the process identification for this communication process, at process block 210. As illustrated by FIG. 2, method 200 returns to the previous process block after storage of the message by message accumulator unit 210, at process block 226. Method 200 continues processing such that file download unit 112 determines whether the file download is complete, at process decision block 216. In one such embodiment, this decision is based on the instructions for installation received from PXE server unit 104 at process block 204. Upon determining that the downloading of files is not complete, file download unit 112 downloads another file from file server 106, at process block 212. This recursive process of downloading a file from file server 106 and transmitting a status message to message accumulator unit 108 continues until the downloading of the files is complete.

Process blocks 212-216 illustrate the transmitting of a status message after each file has been downloaded from file server 106. However, embodiments of the present invention are not so limited, as other updates at different times can be transmitted to message accumulator unit 108 during the file download process. For example, in another embodiment, file download unit 112 could transmit a status message after a designated number, such as ten, files have been downloaded from file server 106. Further, the transmitting of messages from file download unit 112 to message accumulator unit 108 is described in terms of status messages regarding the download of the files from file server 106. This is by way of example and not by way of limitation as other types of messages can be transmitted from file download unit 112 to message accumulator unit 108. For example, file download unit 112 could transmit a different type of status message, such as an update on the transmission speed for the file download. Other examples of the different types of messages could include error messages, such as error in retrieving a file from file server 106.

Returning to FIG. 2, upon determining that the downloading of files is complete, at process decision block 216, control passes to pre-boot environment unit 110. Pre-boot environment unit 110 installs and boots the operating system, at process block 218. Pre-boot environment unit 110 can also transmit status and error messages during the operating system installation to message accumulator unit 108 either directly (not shown) or through PXE server unit 104 through communications 116 and 118.

Moreover, pre-boot environment unit 110 determines whether the new operating system booted, at process decision block 220. Upon determining that the new operating system on client machine 130 did not boot, pre-boot environment unit 110 transmits an error message to message accumulator unit 110 either directly (not shown) or through PXE server unit 104, through communications 116 and 118 at process block 224. Message accumulator unit 108 stores this error message based on the process identification for this communication process, at process block 210. As illustrated by FIG. 2, method 200 returns to the previous process block after storage of the message by message accumulator unit 210, at process block 226. In particular, pre-boot environment unit 110 terminates the communication process, at process block 228.

Conversely, upon determining that the new operating system on client machine 130 did boot, newly installed operating system 114 transmits a status message to message accumulator unit 108, through communication 124 at process block 222. Message accumulator unit 108 stores this status message based on the process identification for this communication process, at process block 210. As illustrated by FIG. 2, method 200 returns to the previous process block after storage of the message by message accumulator unit 210, at process block 226. Accordingly, the communication process is completed, at process block 230.

### Message Retrieval

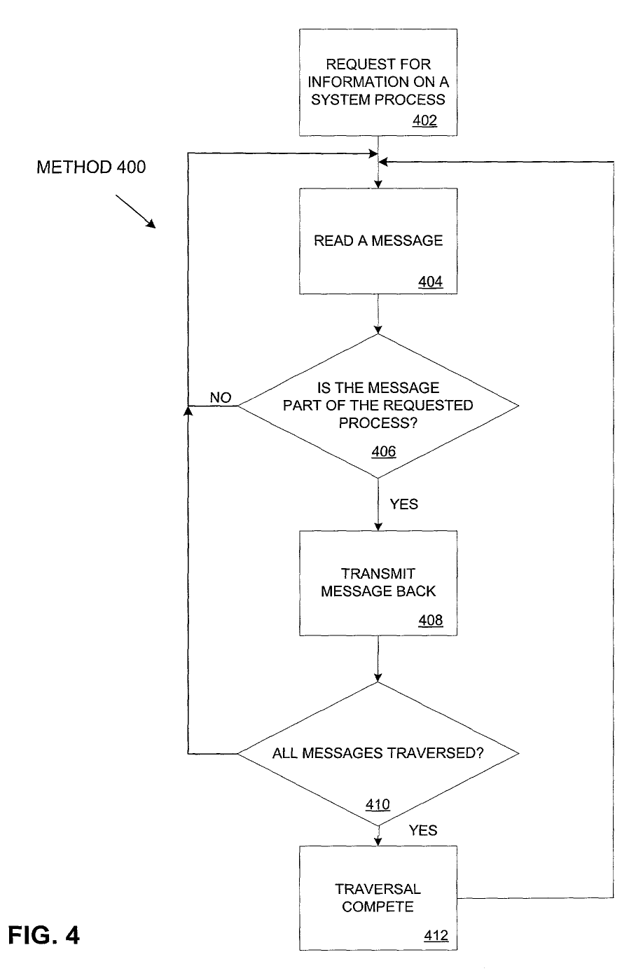

FIG. 4 illustrates a flow diagram of retrieving messages for a given communication process from message accumulator unit 108, according to embodiments of the present invention. Method 400 is described in terms of the storage of the messages within flat file(s) stored in an order based on when the messages are received for accumulation. This is by way of example and not by way of limitation, as other types of storage techniques and/or databases can be incorporated into embodiments of the present invention. For example, in an embodiment, message accumulator unit 108 can employ an object-oriented database, wherein messages for a given communication process are stored within given related objects.

Method 400 commences with a request for information for a communication process, at process block 402. This request can be transmitted by a number of sources. In one embodiment, this request can be transmitted by a system administrator either locally or remotely. In other words, a system administrator can issue this request by transmitting commands locally on server machine 102 or can issue this request from other machines that are communicatively coupled to server machine 102. In other embodiments, scripts executing on server machine 102 and/or remote machines can transmits this request to message accumulator unit 108.

Additionally, this request includes at least identification of the communication process for the messages that need to be retrieved. In an embodiment, as described above, this process identification includes the Ethernet hardware address for the client machine on which the communication process executed. However, embodiments of the present invention are not so limited, as any other type of unique identifier of the communication process can be employed to identify the messages for the process.

Message accumulator unit 108 reads a message from the file(s) in which all messages for the different communication processes are stored, at process block 404. Moreover, message accumulator unit 108 determines whether this message is part of the messages associated with a requested communication process, at process decision block 406. In particular, message accumulator unit 108 compares the process identifier for the requested communication process to the process identifier for the stored message. Returning to FIG. 3 to help illustrate, message accumulator unit 108, in an embodiment, can compare the process identifier for the requested communication process to process identification 302 that is stored within the messages stored by message accumulator unit 108.

Upon determining that the message is not part of the requested communication process, message accumulator unit 108 reads the next message within the files containing the messages, at process block 404. In contrast, upon determining that the message is part of the requested communication process, message accumulator unit 108 transmits this message to the requesting application and/or script, at process block 408. Additionally, message accumulator unit 108 determines whether all of the messages stored within the message file(s) have been traversed, at process decision block 410. Upon determining that all such messages have been traversed, method 400 is complete, at process block 412. Conversely, upon determining that all such messages have not been traversed, message accumulator unit 108 reads the next messages within the message files, returning to process block 404.

As illustrated, embodiments of the present invention allow a system administrator to retrieve all messages, including status and error messages that have been aggregated for one communication process that is executing across multiple system elements across different devices without having to track the execution across different monitors and/or log files located on different devices.

### System Application

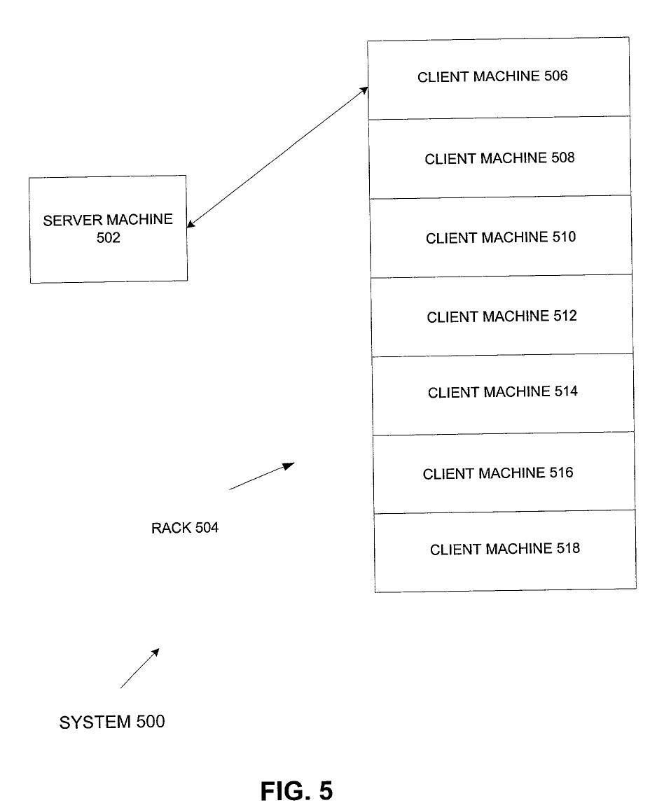

FIG. 5 illustrates a system application for accumulating and retrieving of messages for communication processes, according to embodiments of the present invention. In particular, FIG. 5 illustrates system 500 that includes server machine 502 and rack 504 that includes management client machine 506 and client machines 508-518. In an embodiment, system 500 acts as a data center for Internet web host providers. Server machine 502 is communicatively coupled to rack 504 through management client machine 506. Additionally, management client machine 506 is communicatively coupled (not shown) to client machines 508-518. In an embodiment, management client machine 506 can be communicatively coupled to client machines 508-518 through a back plane of rack 504. In another embodiment, management client machine 506 is communicatively coupled to client machines 508-518 through a communication mesh that couples management client machine 506 and each of client machines 508-518 to one another. In one embodiment, management client machine 506 and client machines 508-518 are headless machines that can be controlled over a web interface by other devices, such as server machine 502. However, embodiments of the present invention are not so limited, as other devices coupled to management client machine 506 and client machines 508-518 can control such devices and can use other protocols and/or interfaces for such control.

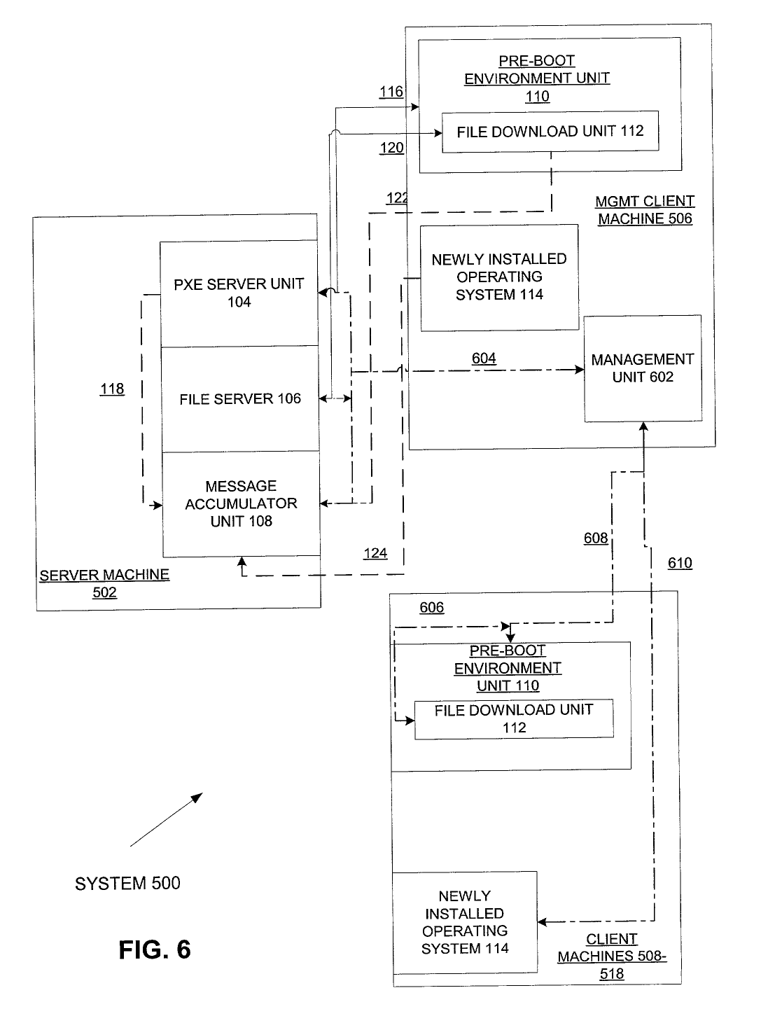

FIG. 6 illustrates a more detailed diagram of a system application for accumulating and retrieving of messages for communication processes, according to embodiments of the present invention. In particular, FIG. 6 illustrates a more detailed diagram of system 500 of FIG. 5. For the sake of simplicity, FIG. 6 illustrates one of client machines 508-518 and its communication with management client machine 506 and server machine 502.

As shown, server machine 502 includes PXE server unit 104, file server 106 and message accumulator unit 108, which have been described above in conjunction with FIGS. 1 and 2. Additionally, management client machine 506 includes pre-boot environment unit 110, file download unit 112 and newly installed operating system 114, which have been described above in conjunction with FIGS. 1 and 2. Management client machine 506 also includes management unit 602. Management unit 602 is communicatively coupled to PXE server unit 104, file server 106 and message accumulator unit 108 through communication 604.

Client machines 508-518 include pre-boot environment unit 110, file download unit 112 and newly installed operating system 114, which have been described above in conjunction with FIGS. 1 and 2. Additionally, pre-boot environment unit 110 of client machines 508-518 is communicatively coupled to management unit 602 through communication 608. File download unit 112 of client machines 508-518 is communicatively coupled to management unit 602 through communication 606. Further, newly installed operating system 114 of client machines 508-518 is communicatively coupled to management unit 602 through communication 610.

In operation, each of client machines 508-518 performs operations and communications with server machine 502, which are similar to those of client machine 130 and server machine 102, as described in conjunction with FIGS. 1 and 2. However, the communications between each of client machines 508-518 and server machine 502 are transmitted through management unit 602 of management client machine 506. For example, when a boot request is transmitted from pre-boot environment unit 110 of client machine 508 to PXE server unit 104 of server machine 502, this request is transmitted to management unit 602 through communication 608, which in turn transmits this request to PXE server unit 104 of server machine 502 through communication 604. Similar communications between the different units or system elements of client machines 508-518 and the different units and system elements of server machine 502 are transmitted through management unit 602 through communications 606 and 610. Additionally, management unit 602 can transmit messages to message accumulator unit 108 for communication processes executing system elements on client machines 508-518. Further, management client machine 506 performs communications with server machine 502 that are similar to those described for client machine 130 and server machine 102.

As shown in FIGS. 5 and 6, a management client machine acts an interface between a number of client machines and a server machine for the storing and accumulating of different messages related to different communication processes executing on these different client machines. System 500 illustrated in FIG. 5 is one example of a system application of embodiments of the present invention. However, other system applications can be incorporated into embodiments of the present invention. For example, other applications do not required a management client machine for interfacing a number of client machines to a server machine. Moreover, in other system applications, multiple management client machines could be employed for interfacing a number of client machines with a number of server machines. In other embodiments of the present invention, one of the number of client machines could be designated as the management client machine. However, in one of such embodiments, the management client machine is not employed to act as an interface between the number of client machines and a server machine for the storing and accumulating of different messages related to different communication processes executing on these different client machines. In one such embodiment, the management client machine could be used to update software packages and perform system checks on the client machines.

### Exemplary Computer System

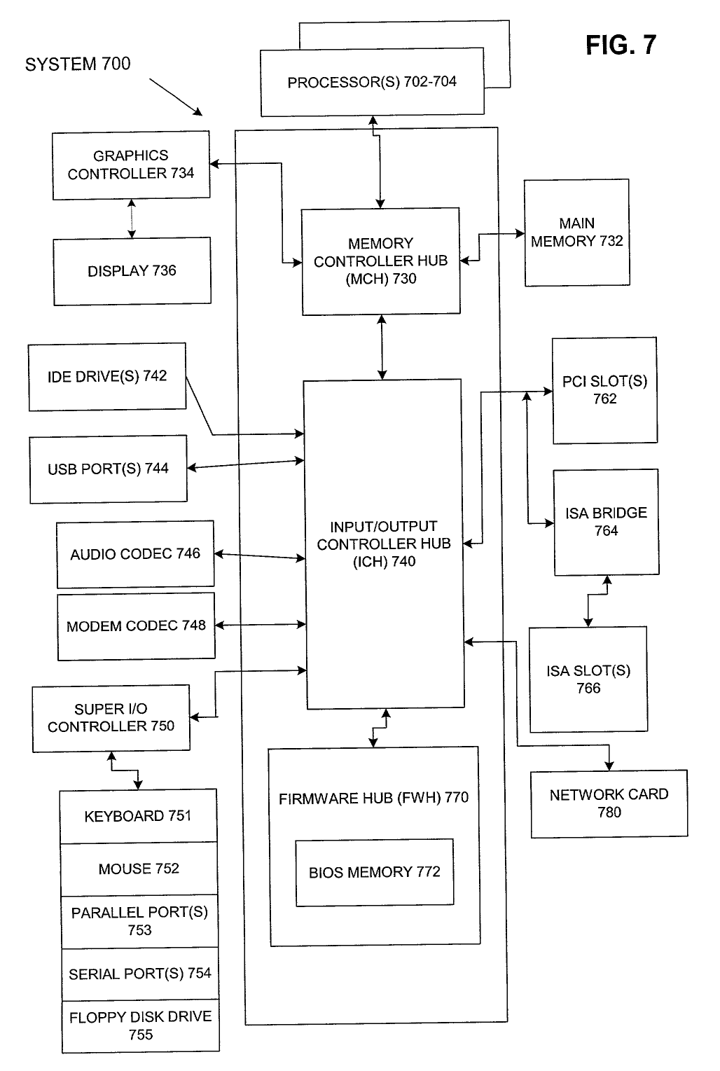

FIG. 7 illustrates a computer system that includes a machine-readable medium on which is stored a set of instructions according to embodiments of the present invention. Although described in the context of computer system 700, the present invention may be implemented in any suitable computer system comprising any suitable one or more integrated circuits.

As illustrated in FIG. 7, computer system 700 comprises processor 702 that may include instructions for message accumulation and retrieval, as described herein. Computer system also can include another processor 704 that may also have instructions for message accumulation and retrieval, as described herein. Computer system 700 also includes processor bus 710, and chipset 720. Processors 702 and 704 and chipset 720 are coupled to processor bus 710. Processors 702 and 704 may each comprise any suitable processor architecture and for one embodiment comprise an Intel® Architecture used, for example, in the Pentium® family of processors available from Intel® Corporation of Santa Clara, Calif. Computer system 700 for other embodiments may comprise one, three, or more processors any of which may execute a set of instructions that are in accordance with embodiments of the present invention.

Chipset 720 for one embodiment comprises memory controller hub (MCH) 730, input/output (I/O) controller hub (ICH) 740, and firmware hub (FWH) 770. MCH 730, ICH 740, and FWH 770 may each comprise any suitable circuitry and for one embodiment is each formed as a separate integrated circuit chip. Chipset 720 for other embodiments may comprise any suitable one or more integrated circuit devices.

MCH 730 may comprise any suitable interface controllers to provide for any suitable communication link to processor bus 710 and/or to any suitable device or component in communication with MCH 730. MCH 730 for one embodiment provides suitable arbitration, buffering, and coherency management for each interface.

MCH 730 is coupled to processor bus 710 and provides an interface to processors 702 and 704 over processor bus 710. Processor 702 and/or processor 704 may alternatively be combined with MCH 730 to form a single chip. MCH 730 for one embodiment also provides an interface to a main memory 732 and a graphics controller 734 each coupled to MCH 730. Main memory 732 stores data and/or instructions, for example, for computer system 700 and may comprise any suitable memory, such as a dynamic random access memory (DRAM) for example. Graphics controller 734 controls the display of information on a suitable display 736, such as a cathode ray tube (CRT) or liquid crystal display (LCD) for example, coupled to graphics controller 734. MCH 730 for one embodiment interfaces with graphics controller 734 through an accelerated graphics port (AGP). Graphics controller 734 for one embodiment may alternatively be combined with MCH 730 to form a single chip.

MCH 730 is also coupled to ICH 740 to provide access to ICH 740 through a hub interface. ICH 740 provides an interface to I/O devices or peripheral components for computer system 700. ICH 740 may comprise any suitable interface controllers to provide for any suitable communication link to MCH 730 and/or to any suitable device or component in communication with ICH 740. ICH 740 for one embodiment provides suitable arbitration and buffering for each interface.

For one embodiment, ICH 740 provides an interface to one or more suitable integrated drive electronics (IDE) drives 742, such as a hard disk drive (HDD) or compact disc read only memory (CD ROM) drive for example, to store data and/or instructions for example, one or more suitable universal serial bus (USB) devices through one or more USB ports 744, an audio coder/decoder (codec) 746, and a modem codec 748. Additionally, ICH 740 is coupled network card 780 to allow system 700 to couple to and communicate with other devices in a network provide, thereby allowing for the receipt and transmission of data in system 700. ICH 740 for one embodiment also provides an interface through a super I/O controller 750 to a keyboard 751, a mouse 752, one or more suitable devices, such as a printer for example, through one or more parallel ports 753, one or more suitable devices through one or more serial ports 754, and a floppy disk drive 755. ICH 740 for one embodiment further provides an interface to one or more suitable peripheral component interconnect (PCI) devices coupled to ICH 740 through one or more PCI slots 762 on a PCI bus and an interface to one or more suitable industry standard architecture (ISA) devices coupled to ICH 740 by the PCI bus through an ISA bridge 764. ISA bridge 764 interfaces with one or more ISA devices through one or more ISA slots 766 on an ISA bus.

ICH is also coupled to FWH 770 to provide an interface to FWH 770. FWH 770 may comprise any suitable interface controller to provide for any suitable communication link to ICH 740. FWH 770 for one embodiment may share at least a portion of the interface between ICH 740 and super I/O controller 750. FWH 770 comprises a basic input/output system (BIOS) memory 772 to store suitable system and/or video BIOS software. BIOS memory 772 may comprise any suitable non-volatile memory, such as a flash memory for example.

Accordingly, computer system 700 includes a machine-readable medium on which is stored a set of instructions (i.e., software) embodying any one, or all, of the methodologies described above. For example, software can reside, completely or at least partially, within main memory 732 and/or within processors 702/704. For the purposes of this specification, the term “machine-readable medium” shall be taken to include any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

[image]

[image]

What is claimed is:

1. A method comprising:
receiving a number of messages from at least two different system elements that are located in two different devices, wherein the system elements are associated with a same process and wherein the number of messages have a common protocol;
storing the number of messages from the at least two different system elements; and
retrieving the number of messages associated with the same process upon request for a status inquiry of the same process.

2. The method of claim 1, wherein the same process includes an installation of an operating system onto one of the two different devices.

3. The method of claim 1, wherein the common protocol includes the HyperText Transfer Protocol.

4. The method of claim 1, wherein the number of messages are based on a message format wherein the message format includes a process identification and an information code.

5. The method of claim 4, wherein the process identification includes an Ethernet hardware address for one of the two different devices.

6. A method comprising:
receiving a number of messages from different system elements that are associated with different communication processes, wherein the different system elements are located on server machines and client machines, wherein the number of messages are based on the HyperText Transfer protocol and have a process identification that includes an Ethernet hardware address for the client machine;
storing the number of messages from the at least two different system elements; and
retrieving the number of messages associated with a communication process of the different communication processes upon request for a status inquiry of the communication process.

7. The method of claim 6, wherein the communication process of the different communication processes includes a process for installing an operating system onto one of the client machines.

8. The method of claim 6, wherein the client machines include a management client machine, wherein the number of messages received from the different system elements located on the client machines are transmitted through the management client machine.

9. The method of claim 8, wherein the client machines are part of a data center for a number of Internet web host providers.

10. An apparatus comprising:
a local execution unit communicatively coupled to a remote execution unit, wherein the remote execution unit is located on a remote device that is coupled to the apparatus and wherein the local execution unit and the remote execution unit are to execute as part of a same process; and
a message accumulator unit communicatively coupled to the local execution unit and the remote execution unit, wherein the message accumulator unit is to receive messages from the local execution unit and the remote execution unit using a common protocol.

11. The apparatus of claim 10, wherein the same process includes an installation of an operating system onto the remote device.

12. The apparatus of claim 10, wherein the common protocol includes the HyperText Transfer Protocol.

13. The apparatus of claim 10, wherein the number of messages are based on a message format wherein the message format includes a process identification and an information code.

14. The apparatus of claim 13, wherein the process identification includes an Ethernet hardware address for one of the two different devices.

15. A system comprising:
a client machine that includes at least one system element; and
a server machine that includes at least one system element and a message accumulator unit, wherein the message accumulator unit is to receive and store messages from the at least one system elements on the client machine and the server machine during an installation of an application onto the client machine, wherein the messages are based on a common protocol and using a same message format, the same message format to include a process identification that includes an Ethernet hardware address of the client machine.

16. The system of claim 15, wherein the installation of the application includes an installation of an operating system onto the client machine.

17. The system of claim 15, wherein the common protocol includes the HyperText Transfer Protocol.

18. The system of claim 15, wherein the server machine further comprises a file server, wherein one of the at least system elements on the client machine is to download files from the file server during the installation of the application.

19. A machine-readable medium that provides instructions, which when executed by a machine, causes the machine to perform operations comprising:
receiving a number of messages from at least two different system elements that are located in two different devices, wherein the system elements are associated with a same process and wherein the number of messages have a common protocol;
storing the number of messages from the at least two different system elements in memory; and
retrieving the number of messages associated with the same process upon request for a status inquiry of the same process.

20. The machine-readable medium of claim 19, wherein the same process includes an installation of an operating system onto one of the two different devices.

21. The machine-readable medium of claim 19, wherein the common protocol includes the HyperText Transfer Protocol.

22. The machine-readable medium of claim 19, wherein the number of messages are based on a message format wherein the message format includes a process identification and an information code.

23. The machine-readable medium of claim 22, wherein the process identification includes an Ethernet hardware address for one of the two different devices.

24. A machine-readable medium that provides instructions, which when executed by a machine, causes the machine to perform operations comprising:
receiving a number of messages from different system elements that are associated with different communication processes, wherein the different system elements are located on server machines and client machines, wherein the number of messages are based on the HyperText Transfer protocol and have a process identification that includes an Ethernet hardware address for the client machine;
storing the number of messages from the at least two different system elements; and
retrieving the number of messages associated with a communication process of the different communication processes upon request for a status inquiry of the communication process.

25. The machine-readable medium of claim 24, wherein the communication process of the different communication processes includes a process for installing an operating system onto one of the client machines.

26. The machine-readable medium of claim 24, wherein the client machines include a management client machine, wherein the number of messages received from the different system elements located on the client machines are transmitted through the management client machine.

27. The machine-readable medium of claim 26, wherein the client machines are part of a data center for a number of Internet web host providers.
